(19) United States
(12) Patent Application Publication
(10) Pub. No.: US 2015/0234180 A1
(43) Pub. Date: Aug. 20, 2015

(54) System and Method for Selecting Safer Colored Ophthalmic Spectacle, Contact, Intraocular or other Lenses and Filters by Comparing the Proportion of Harmful Higher Energy Visible and Near Visible Radiation Blocked to the Light Passed by the Lens in the Photopic Region

(71) Applicants: Herbert A. Wertheim, Miami, FL (US); Phillip R. Bartick, Miami, FL (US); William F. Moore, Miami, FL (US)

(72) Inventors: Herbert A. Wertheim, Miami, FL (US); Phillip R. Bartick, Miami, FL (US); William F. Moore, Miami, FL (US)

(21) Appl. No.: 14/182,768

(22) Filed: Feb. 18, 2014

(51) Int. Cl. G02B 27/00; G02C 7/10

(52) U.S. Cl. CPC G02B 27/0012; G02C 7/10

(57) ABSTRACT

A system and method for selecting safer colored ophthalmic spectacle, contact, intraocular and other lenses and filters by quantifying the amount of harmful, higher energy visible and near visible radiation blocked by it compared to the overall visible radiation passing through it is described. A figure of merit, which is produced by the method, is the Wertheim Factor, whose value is nearly 50% for lenses which block the harmful high energy radiation compared to beneficial light and is nearly 0% for lenses which pass all radiation equally. This method includes using a computer program to sample the visible and near visible transmission spectrum of said colored filter or colored ophthalmic spectacle, contact, intraocular or other lens and then evaluate the energy content of the photons present.

### BACKGROUND OF THE INVENTION

1. Field of the Invention:

The invention relates to a method to be used in the field of optometry, ophthalmology and optics in general to provide a figure of merit to assist in the selection of colored filters and colored ophthalmic spectacle, contact, intraocular and other lenses which block most harmful high energy radiation while still passing useful visible light.

2. Background of the Related Art

The selection by an end user of an appropriate colored filter or colored ophthalmic spectacle, contact, intraocular or other lens is difficult. In recent years, it has become apparent that higher energy, shorter wavelength radiation in the ultraviolet and visible spectrum may prove damaging to the human eye. Many types of lens filtering systems for ophthalmic spectacle, contact, intraocular and other lenses to protect the eye from this threat have been described. Stephens, et al., has described such an optical lens with selective transmissivity function in U.S. Pat. No. 4,952,046 reissue RE 38,402. In U.S. Pat. Nos. 8,360,574 and 8,403,478 Ishak, et al. has also described lenses with selective light filtering to protect the integrity of the macula and provide improved contrast sensitivity.

### SUMMARY OF THE INVENTION

Such lenses and filters undoubtedly provide protection from harmful, high-energy radiation or photons, but many other colored filters exist with slightly different characteristics from those described in those patents. The end user, in order to compare lenses would benefit from a single figure of merit which would compare the proportion of high energy radiation blocked to the amount of less harmful radiation passed by the lens in the peak of the eye's response, the photopic region.

The method herein described utilizes a computer algorithm to analyze the transmission spectrum of an ophthalmic lens or filter. It then takes a ratio of the total energy blocked by the filter in the spectral region under study to the total optical energy available in the spectral region under study. This ratio is then multiplied by the luminous transmittance of the filter. The algorithm then outputs this figure of merit, the Wertheim Factor, expressed as a percentage. The actual value will change depending on the wavelength range chosen so that when comparing lenses, they must all be evaluated over the same spectral range. In order to be meaningful, the spectral range must include the photopic region, centered on 550 nm, as well as the region of the spectrum considered to be harmful. In the preferred embodiment, the spectral range used is from 315 nm to 780 nm.

### DETAILED DESCRIPTION OF THE INVENTION

The mathematical description of the algorithm to be employed to produce the Wertheim Factor is described as follows:

Let En₁ be the total energy available to pass through the lens or filter in the

spectral range from λ_{low} to λ_{high} as

$${En}_{1} = {\int }_{{λ}_{low}}^{{λ}_{high}} En ( λ ) d λ$$

where En(λ) is the spectral power distribution of the available optical radiation or photons as a function of wavelength, λ. If a flat energy source is assumed so that there are equal numbers of photons at each wavelength, En(λ) can be represented by

$$En ( λ ) = K \frac{{λ}_{low}}{λ} .$$

If the transmittance of the lens or filter as a function of wavelength is τ(λ), then the radiation blockage of the lens or filter is (1−τ(λ)) and the energy blocked by the lens or filter will be given by

$${En}_{2} = {\int }_{{λ}_{low}}^{{λ}_{high}} ( 1 - τ ( λ ) ) En ( λ ) d λ .$$

The luminous transmittance of a lens or filter, τ_{V}, has been defined to be

$${τ}_{v} = \frac{{\int }_{380}^{780} τ ( λ ) V ( λ ) {S}_{C} ( λ ) d λ}{{\int }_{380}^{780} V ( λ ) {S}_{C} ( λ ) d λ}$$

where V(λ) is the spectral ordinate of the photopic luminous efficiency distribution, y(λ), of the CIE (1931) standard colorimetric observer and S_{C}(λ) is the spectral intensity of the standard illuminant C, as taught by the American National Standard publication, ANSI Z80.3-2001, and elsewhere.

The Wertheim Factor is then defined to be

$$W . F . = \frac{( {En}_{2} ) ( {τ}_{V} )}{{En}_{1}} .$$

Clearly, if no radiation is blocked by the lens or filter, En₂ is zero and the Wertheim Factor is zero, demonstrating that a totally transparent lens offers no protection to the eye from harmful radiation. Also, if the lens were totally opaque, τ_{V} would be zero as would the Wertheim Factor, indicating that although the lens or filter protected the eye from harmful radiation, it also blocked all visible radiation so that the eye could not see. The Wertheim factor reaches a maximum value when the radiation on the short wavelength side of the photopic spectral region is blocked while the visible light within the photopic spectrum is passed by the lens or filter. A lens filter color such as that produced when a lens is tinted with the specialty Brain Power Incorporated tint Total Day™ to its specified density yields a Wertheim Factor of 0.416 (41.6%), while a more common tint such as Brain Power Incorporated tint B&L G-15™ gives a Wertheim Factor of only 0.136 (13.6%).

If a Wertheim Factor based on the sun's actual irradiance at sea level is sought, then E(λ), the Solar Irradiance at sea level as described in the American National Standard publication, ANSI Z80.3-2001, and elsewhere, may be used in place of En(λ).

For numerical computation, the computer algorithm will employ discrete sums in place of the integrals described above. Specifically,

$${En}_{1} = {\sum }_{{λ}_{low}}^{{λ}_{high}} En ( λ ) Δλ$$

where Δλ is less than or equal to 10 nm. Further,

$${En}_{2} = {\sum }_{{λ}_{low}}^{{λ}_{high}} ( 1 - τ ( λ ) ) ( En ( λ ) ) ( Δλ ) and {τ}_{V} = \frac{{\sum }_{380}^{780} ( τ ( λ ) ) ( V ( λ ) ) ( {S}_{C} ( λ ) ) ( Δλ )}{{\sum }_{380}^{780} ( V ( λ ) ) ( {S}_{C} ( λ ) ) ( Δλ )}$$

where Δλ is of the same size as was used to find En₁.

We claim:

1. A system and method for selecting safer colored ophthalmic spectacle, contact, intraocular or other lenses and filters by comparing the proportion of harmful, higher energy visible and near visible radiation blocked to the light passed by the lens in the photopic region producing a figure of merit, the Wertheim Factor, comprising an algorithm whose mathematical description is described as follows: let En₁ be the total energy available to pass through the lens or filter in the spectral range from λ_{low} to λ_{high} as
$${En}_{1} = {\int }_{{λ}_{low}}^{{λ}_{high}} En ( λ ) d λ$$
where En(λ) is the spectral power distribution of the available optical radiation or photons as a function of wavelength, λ; if a flat energy source is assumed so that there are equal numbers of photons at each wavelength, En(λ) can be represented by
$$En ( λ ) = K \frac{{λ}_{low}}{λ} ;$$
if the transmittance of the filter, ophthalmic spectacle, contact, intraocular or other lens as a function of wavelength is τλ, then the radiation blockage of the lens or filter is (1−τ(λ)) the energy blocked by the lens or filter will be given by
$${En}_{2} = {\int }_{{λ}_{low}}^{{λ}_{high}} ( 1 - τ ( λ ) ) En ( λ ) d λ ;$$
the luminous transmittance of a the lens or filter, τ_{V}, has been defined to be
$${τ}_{V} = \frac{{\int }_{380}^{780} τ ( λ ) V ( λ ) {S}_{C} ( λ ) d λ}{{\int }_{380}^{780} V ( λ ) {S}_{C} ( λ ) d λ}$$
where V(λ) is the spectral ordinate of the photopic luminous efficiency distribution, y(λ), of the CIE (1931) standard colorimetric observer and S_{C}(λ) is the spectral intensity of the standard illuminant C, as taught by the American National Standard publication, ANSI Z80.3-2001, and elsewhere; the Wertheim Factor is then defined to be
$$W . F . = \frac{( {En}_{2} ) ( {τ}_{V} )}{{En}_{1}} ;$$
if no radiation is blocked by the lens or filter, En₂ is zero and the Wertheim Factor is zero, demonstrating that a totally transparent lens offers no protection to the eye from harmful radiation; if the lens were totally opaque, τ_{V} would be zero as would the Wertheim Factor, indicating that although the lens or filter protected the eye from harmful radiation, it also blocked all visible radiation so that the eye could not see; the Wertheim factor reaches a maximum value when the radiation on the short wavelength side of the photopic spectral region is blocked while the visible light within the photopic spectrum is passed by the lens or filter.

2. A method or system according to claim 1 wherein the Wertheim Factor is based on the sun's actual irradiance at sea level , E(λ); the Solar Irradiance at sea level as described in the American National Standard publication, ANSI Z80.3-2001, and elsewhere, and it is then used in place of En(λ) utilized in claim 1.

3. A method or system according to claim 1 wherein the Wertheim Factor is derived using numerical computation; a computer algorithm will employ discrete sums in place of the integrals described in claim 1; specifically,
$${En}_{1} = {\sum }_{{λ}_{low}}^{{λ}_{high}} En ( λ ) Δλ$$
where Δλ is less than or equal to 10 nm;
$${En}_{2} = {\sum }_{{λ}_{low}}^{{λ}_{high}} ( 1 - τ ( λ ) ) ( En ( λ ) ) ( Δλ ) and {τ}_{V} = \frac{{\sum }_{380}^{780} ( τ ( λ ) ) ( V ( λ ) ) ( {S}_{C} ( λ ) ) ( Δλ )}{{\sum }_{380}^{780} ( V ( λ ) ) ( {S}_{C} ( λ ) ) ( Δλ )}$$
where Δλ is of the same size as was used to find En₁; the Wertheim factor remains defined as
$$W . F . = \frac{( {En}_{2} ) ( {τ}_{V} )}{{En}_{1}} ,$$
using the numerically found values for En₂, En₁ and τ_{V}.
